(19) United States
(12) Patent Application Publication
(10) Pub. No.: US 2024/0416777 A1
(43) Pub. Date: Dec. 19, 2024

(54) OPERATING ELEMENT FOR TRANSPORTING A CHARGING CABLE FOR CHARGING A VEHICLE

(71) Applicant: Siemens Aktiengesellschaft, München (DE)

(72) Inventors: Albert Völkl, München (DE); Stefan Perras, Eichenau (DE)

(21) Appl. No.: 18/743,374

(22) Filed: Jun. 14, 2024

(30) Foreign Application Priority Data
Jun. 14, 2023 (DE) 10 2023 205 522.8

(51) Int. Cl. B60L 53/35; B60L 53/16; B60L 53/18; H02G 11/02

(52) U.S. Cl. CPC B60L 53/35; B60L 53/16; B60L 53/18; H02G 11/02

(57) ABSTRACT

A device for controlling a charging cable for charging a vehicle has a carrier structure arranged at a charging zone. A charging cable that is fastened to the carrier structure and connected to an electricity source carries a charging plug for plugging into the vehicle to be charged. A cable transport device has a cable transport element which is coupled to the charging cable in such a way that the charging cable is movable relative to the carrier structure. The cable transport device further has an operating element which is coupled to the cable transport element in such a way that control commands for controlling the cable transport element can be input by a user in order to position the charging plug in the charging zone.

### CROSS-REFERENCE TO RELATED APPLICATION

This application claims the priority, under 35 U.S.C. § 119, of German Patent Application DE 10 2023 205 522.8, filed Jun. 14, 2023; the prior application is herewith incorporated by reference in its entirety.

### FIELD AND BACKGROUND OF THE INVENTION

The present invention relates to a device and a method for transporting a charging cable for charging a vehicle.

In addition to the electrification of smaller vehicles, such as automobiles, it is also possible to electrify commercial vehicles, such as trucks. The operation of commercial vehicles is highly cost-driven, which is why, when they are electrified, additional downtimes caused by charging breaks for the high voltage battery have to be avoided. For this reason, it is advantageous to construct a charging infrastructure, for example at the loading and unloading sites of trucks. Since there is often little space to maneuver in truck or bus depots, it is difficult to anchor conventional charging columns or charge distributors (dispensers) firmly in the ground. The risk of damage due to maneuvering operations and thus the failure of the charger is too high.

One possible way of reducing the risk of damage is to fit the dispenser at a sufficient distance above the roadway. In this case, however, the cable management of the charging cables poses a particular challenge, since the charging plug of the charging cable or the truck itself should not be damaged during maneuvering. It is therefore appropriate to position the charging cable outside or at a sufficient distance from a charging zone after the charging process. However, the positioning of a charging cable by the user alone is problematic, since the charging cable is very heavy and is often heavily contaminated by the environment.

### SUMMARY OF THE INVENTION

It is accordingly an object of the invention to provide a charging cable handling device which overcomes the above-mentioned disadvantages of the heretofore-known devices and methods of this general type and which introduces techniques that allow easy transport of a charging cable.

With the above and other objects in view there is provided, in accordance with the invention, a device for transporting a charging cable for charging a vehicle, the device comprising:
a carrier structure to be arranged at a charging zone for charging a vehicle;
a charging cable fastened to the carrier structure, the charging cable being connected, or connectible to an electricity source and having a charging plug for plugging into the vehicle to be charged;
a cable transport device having a cable transport element that is coupled to the charging cable and is configured to move the charging cable relative to the carrier structure;
the cable transport device further having an operating element coupled to the cable transport element and configured to receive control commands from a user for controlling the cable transport element, and the cable transport device being configured to move the charging plug in the charging zone in dependence on control commands received from the user.

In other words, according to a first aspect of the invention, there is described a device for transporting a charging cable for charging a vehicle. The device has a carrier structure which is designed to be arranged at a charging zone for charging a vehicle. The device has a charging cable, which is connected or can be connected to an electricity source, and a charging plug for plugging into a vehicle to be charged. The charging cable is fastened to the carrier structure. The device further has a cable transport device having a cable transport element which is coupled to the charging cable and is designed to move the charging cable relative to the carrier structure. The cable transport device further has an operating element which is coupled to the cable transport element and which is designed to receive control commands for controlling the cable transport element from a user. The cable transport device is designed to move the charging plug in the charging zone depending on the received control commands.

According to a further aspect of the invention, there is described and claimed a method for transporting a charging cable for charging a vehicle using the device described above. The method comprises positioning the charging plug in the charging zone based on control commands that are input to the operating element for controlling the cable transport element.

The vehicle may represent an electrically operated vehicle, for example a purely electrically operated vehicle or a hybrid vehicle, which has a rechargeable battery. The vehicle has in particular a charging socket into which the charging plug of the charging cable is pluggable. The vehicle is for example an electrically operated automobile or a commercial vehicle, for example a truck, a bus, a construction machine or an agricultural machine.

The charging zone describes a region of the ground in which the charging cable can be moved in order to be coupled to the vehicle and to charge the vehicle accordingly. The charging zone has a predetermined area on the ground, wherein the charging plug can be plugged into the vehicle in the charging zone. At the same time, the charging zone may be provided for loading the vehicle with goods to be transported or unloading transported goods from the vehicle.

The carrier structure serves for fastening the device components to a building or to the ground. The carrier structure carries the charging cable in particular. Furthermore, the cable transport device with the corresponding cable transport element can be provided on the carrier structure. Furthermore, sensor elements of the sensor device for detecting the charging situation can be arranged. In another exemplary embodiment, an electricity source and/or a charge distributor (dispenser), to which the charging cable is coupled, is/are arranged on the carrier structure. The carrier structure is designed, for example, as a ground support or as a crossbeam.

The cable transport device has one or more cable transport elements. The cable transport element is coupled to the charging cable and is designed to move the charging cable relative to the carrier structure. The cable transport element is preferably designed to transport regions of the charging cable, in particular the charging plug, from outside into the charging zone. As described below, the cable transport element can be a control rod which is pivotably fastened to the carrier structure, for example. The length of the control rod may also be adjustable. In another exemplary embodiment described below, the cable transport device can be a cable pull device and the cable transport element can be a carrier cable, for example. In addition, a cable winch for rolling up the charging cable can be provided as a cable transport element.

The operating element constitutes an input option, with the result that a user can input control commands for controlling the cable transport element. For this purpose, the operating element can have a multiplicity of different mechanical input options, such as buttons, sliders or switches. Furthermore, the operating element may have a touch-sensitive (for example capacitive or resistive) screen (touchscreen) in order to receive control commands from a user.

The cable transport device can be controlled depending on the control commands. The control commands specify, for example, the cable length of the charging cable or specify position data or movement data for a control mechanism of the cable transport element. These data can be absolute values or values determined relative to a current position.

If the vehicle is in the charging zone, the user can actuate the operating element in order to control the cable transport device and thus move or position the charging plug in the vicinity of the charging socket of the vehicle. After the charging process, the user can use the operating element to control the cable transport device accordingly in order to remove the charging cable or the charging plug from the vehicle, so that the vehicle can drive out of the charging zone with at least a reduced risk of damage to the charging cable.

The present invention makes it possible for the user to position the charging cable or the charging plug in the vicinity of the vehicle without his own muscular strength and without direct contact with the charging cable or the charging plug. Thus, even charging cables of large length and diameter are easy to handle despite a correspondingly large weight.

According to another exemplary embodiment, the operating element is arranged on the carrier structure. The operating element is therefore a stationary component which is fixed and is always present at the same location. For example, the carrier structure can represent a ground support or a charging column, on which the operating element is ergonomically conveniently arranged, so that a user can easily operate the operating element.

According to another exemplary embodiment, the operating element is arranged on the charging cable, in particular on the charging plug. This means that the operating element moves together with the charging plug. The user can grasp the charging plug and control it in its position via the attached operating element, using only a small amount of physical force. The user can thus guide the operating element, together with the charging plug, to a desired position, wherein the movement forces are generated completely or almost completely by the cable transport device and not by the user. The user only inputs appropriate control commands via the operating element. Alternatively, the operating element, as a force sensor, may be designed to detect tensile forces exerted by the user on the charging cable and to receive them as control commands. In this case, the device according to the invention acts as an automatic servo and automatically adjusts the charging cable in the direction of the tensile forces exerted by the user.

According to another exemplary embodiment, the cable transport device has a receiving device for wirelessly receiving the control commands from the operating element, wherein the operating element has a transmitting device for transmitting the control commands input by the user to the receiving device. The operating element and the cable transport device are thus configured for wireless data exchange. The operating element can be arranged away from the cable transport device without the need for a wired connection. For example, various transmission technologies, such as NFC (Near Field Communication), WLAN (Wireless Local Area Network) or Bluetooth transmission standards, can be used for wireless data exchange.

According to another exemplary embodiment, the operating element can be accordingly coupled wirelessly to the cable transport device for the purpose of transmitting the control commands. In another exemplary embodiment, a computer, a smartphone and/or a tablet computer can be understood as an operating element. For example, a corresponding software application (app) can be installed on the operating element in order to receive control commands for the cable transport device.

According to another exemplary embodiment, the operating element has a display element which is configured to indicate information regarding the actual position of the charging plug and/or to display information regarding the charging state of the charging cable. For example, the display element may have information lights, such as LEDs, in order to display specific information to the user. In particular, the display element may be a screen on which, for example, the position of the charging plug in relation to the charging zone or the vehicle is shown, in particular in real time.

For this purpose, the device may have, for example, a sensor device which determines the position and orientation of the vehicle and accordingly its charging socket by means of at least one of various sensors (optical sensors, cameras, touch sensors, etc.) and transmits this display information to the operating element for display on the display element.

The display element can also display information about the charging state, for example whether a current flow or a charging process is active or what the current state of charge of the battery to be charged is.

According to another exemplary embodiment, the operating element can be coupled, in a wireless or wired manner, to an electricity source for charging the vehicle in such a way that control commands for controlling a charging process can be input by the user by means of the operating element. For example, the electricity source can be a charge distributor (dispenser). In addition to the control function of the position of the charging plug, the operating element can thus also have a control function with regard to the charging process. For example, the operating element can send control commands regarding the start and completion of a charging process to the electricity source or to an intermediate control unit.

According to another exemplary embodiment, the operating element has a piezoelectric element which is configured to generate a control signal, in particular without additional energy provision, by means of actuation by the user. The operating element has, for example, a switch which transfers the mechanical energy to the piezoelectric element, with the result that the piezoelectric element converts the mechanical energy into electromagnetic energy or electromagnetic waves. Based on this, it is possible to generate control signals which can be transmitted to the cable transport device. An additional supply battery for the operating element is therefore unnecessary.

According to another exemplary embodiment, the cable transport element forms a control rod which is designed to be longitudinally adjustable and/or which can be pivoted in such a way that the charging cable can be pivoted into and out of the charging zone. For example, the charging cable can be coupled to the control rod at one or more fastening points. The charging cable may have loops between the individual fastening points. For example, if the length of the control rod is reduced, large and tight loops exist between the fastening points. When the control rod is extended to its maximum length, the charging cable may be stretched between the fastening points. The control rod may be designed, for example, to be foldable or retractable in a telescopic manner.

Furthermore, the control rod can be fastened to the carrier structure, for example, in a pivotable manner by means of a hinge in order to thus pivot the charging cable into or out of the charging zone. The change in length or the pivoting of the control rod can be performed, for example, by means of an electrical actuator.

The operating element is configured to receive control commands with respect to a pivoting and/or with respect to a length of the control rod.

According to another exemplary embodiment, the cable transport element has a cable winch which is designed to roll up or unroll the charging cable, wherein the operating element is configured to receive control commands with respect to a rolling-up or unrolling of the charging cable. In particular, the cable winch is an electrically drivable cable winch. Accordingly, control signals can be transmitted from the operating element to the cable winch and the charging cable can be rolled up or unrolled. In particular, the cable winch is mounted in a crossbeam which runs transversely above the ground at a distance from the latter. In particular, the crossbeam is mounted above the ground in such a way that the vehicle to be charged can be positioned between the ground and the crossbeam. Accordingly, when unrolling the charging cable, the charging plug is lowered vertically from the top down until the user can grasp the charging plug and plug it into the charging socket of the vehicle. After the charging process, the user can use the operating element to actuate the cable winch such that the charging cable is rolled up and the charging plug can be moved upward away from the ground. This allows the charging plug to be positioned outside the danger region, with the result that a collision with the charging plug or charging cable can be avoided when maneuvering the vehicle.

According to another exemplary embodiment, the cable transport device is fastened to the carrier structure. Furthermore, the cable transport device has a cable pull device having a carrier cable as a cable transport element. The carrier cable is fastened between a suspension point of the charging cable and the carrier structure, wherein the cable pull device is designed to adjust a free length of the carrier cable such that a distance between the first suspension point and the ground can be variably specified. The operating element is coupled to the cable pull device and is designed to receive control commands with respect to the free length of the carrier cable. In particular, the operating element can be used to control the cable pull device, which for example has an electrical cable winch on which the charging cable is rolled up, and thus to adjust the desired position of the charging plug in the charging zone.

The cable pull device is fastened to the carrier structure, comprising, for example, a crossmember which runs transversely over the charging zone, and has the carrier cable which fastens the charging cable at the suspension point. In other words, the charging cable hangs down from the carrier structure by way of the carrier cable. The carrier cable can be fastened to the charging cable, for example in a detachable or non-detachable manner, at the first suspension point. The suspension points define the section or point at which the corresponding carrier cables are fastened to the charging cable.

The carrier cables can be produced, for example, from plastic or from natural materials, such as hemp. Further, within the scope of the present invention, a chain, for example made of metal, or a strap or belt may also be a carrier cable.

The distance to the ground is adjusted individually by adjusting the free cable lengths of the carrier cables. Thus, in an inactive state in which no vehicle is positioned in the charging zone, the suspension point can be adjusted in the direction of the carrier structure by means of the operating element such that the charging cable is far from the ground in the vicinity of the carrier structure. After a vehicle has maneuvered, in particular under the carrier structure, and is positioned at a predetermined position or charging position relative to the carrier structure, the cable length of the carrier cable can be increased specifically by means of control by way of the operating element such that a user can grasp the charging plug and can plug it into the charging socket of the vehicle.

According to another exemplary embodiment, the cable transport device has a further cable pull device having a further carrier cable as a cable transport element, wherein the further cable pull device is fastened to the carrier structure at a distance from the cable pull device. The further carrier cable is fastened between a further suspension point of the charging cable, which is at a distance from the suspension point, and the carrier structure, wherein the cable pull device and the further cable pull device are each designed to adjust the free lengths of the carrier cable and of the further carrier cable independently of one another such that a respective distance of the suspension point and of the further suspension point to the ground can be variably specified. The operating element is coupled to the further cable pull device and is designed to receive control commands with respect to the free length of the further carrier cable.

According to the exemplary embodiment, the carrier cables are fastened to the carrier structure at a distance from one another and hold corresponding sections of the charging cable at suspension points that are at a distance from one another. Each of the carrier cables can individually adjust the distance between the corresponding suspension point and the carrier structure. In the case of an arrangement having two cable pull devices, the charging cable first of all extends from a coupling point on the carrier structure to the cable pull device, or to a coupling at the one suspension point. From there, the charging cable extends to the further cable pull device, or to the further suspension point on the further carrier cable. From the second suspension point, the charging cable extends onward as far as its end, at which the charging plug is arranged. In another exemplary embodiment, yet further cable pull devices with further suspension points can be provided after the second suspension point.

Accordingly, the cable pull device is fastened, in a detachable or non-detachable manner, to the charging cable at the further suspension point by way of the further carrier cable, such that the charging cable is suspended from the carrier structure by way of the further carrier cable. Depending on the position and orientation of the vehicle in the charging zone, the cable transport device can adjust the lengths of the carrier cables such that not only a vertical but also a horizontal position of the charging plug can be automatically adjusted.

According to another exemplary embodiment, the charging cable extends from a coupling point with the carrier structure to the suspension point and then to the further suspension point, wherein the charging cable is arranged on the carrier structure, the cable pull device and the further cable pull device in such a way that the coupling point is between the suspension point and the further suspension point along a horizontal direction component.

In other words, the charging cable initially hangs down from the carrier structure from the coupling point. Subsequently, the charging cable extends to the first suspension point, forms a loop and extends in the opposite direction to the second suspension point. The region of the charging cable between the coupling point and the second suspension point thus forms a C-shaped course. The region of the loop at the first suspension point can be adjusted flexibly in the direction of the ground. Accordingly, the region at the charging plug or at the second suspension point can also be adjusted flexibly in the direction of the ground. The shape of the cable course of the charging cable can be set depending on how the length ratios between the first carrier cable and the second carrier cable are formed. Since the carrier cables are arranged in an immovable manner, i.e. so as not to be movable along the charging cable, a different setting of the cable lengths of the carrier cables not only changes a vertical position of the suspension points above the ground, but also changes a horizontal position of the suspension points and accordingly of the charging plug. With the described exemplary embodiment, it is thus possible, in addition to a vertical position, for a horizontal position of the charging plug to likewise be set without the user having to use significant muscular strength and without the vehicle needing to be positioned exactly at a predetermined position for charging.

According to another exemplary embodiment, the cable pull device has an electrically controllable cable winch, wherein the cable winch can be controlled based on the detected charging situation. In particular, this adjusts the length of the corresponding carrier cable. The cable winch has for example an electric drive motor, which drives the cable winch as appropriate. Accordingly, the further cable pull device may also have an electrically controllable cable winch which is controlled by the cable transport device.

Thus, according to the invention, one or more electrical cable winches can be controlled with the operating element. This allows the user to adjust the length of the carrier cables individually based on the control of the cable winches, with the result that an exact positioning of the charging plug can be set.

It should be noted that the embodiments described herein represent only a limited selection of possible embodiment variants of the invention. Thus, it is possible to combine the features of individual embodiments suitably with one another such that a multiplicity of different embodiments should be considered to be disclosed to a person skilled in the art with the embodiment variants that are explicit here.

Other features which are considered as characteristic for the invention are set forth in the appended claims.

Although the invention is illustrated and described herein as being embodied in an operating element for transporting a charging cable for charging a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic representation of a device according to the invention, in which the cable transport element is designed as a control rod and a vehicle is located in the charging zone, according to one exemplary embodiment.

FIG. 2 shows a schematic representation of a device according to the invention, in which the cable transport element is designed as a cable winch and a vehicle is located in the charging zone, according to one exemplary embodiment.

FIG. 3 shows a schematic representation of the cable transport device having two cable pull devices, wherein a vehicle is positioned in the charging zone, according to one exemplary embodiment of the present invention.

FIG. 4 shows a schematic representation of the device according to the invention from FIG. 3, wherein no vehicle is located in the charging zone.

Identical or similar components are identified with the same reference signs throughout the figures. The illustrations in the figures are schematic and they are not to scale.

### DETAILED DESCRIPTION OF THE INVENTION

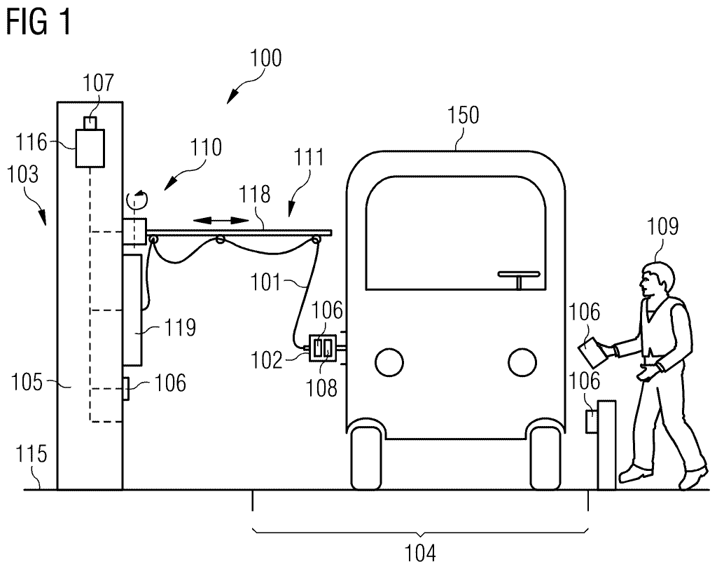

Referring now to the figures of the drawing in detail and first, in particular, to FIG. 1 thereof, there is shown a schematic representation of a device 100 according to the invention, in which the cable transport element 111 is configured as a control rod 118 and a vehicle 150 is located in the charging zone 104. The device 100 has a carrier structure 103 which is arranged at a charging zone 104 for charging a vehicle 150 and has a charging cable 101, which can be connected to an electricity source, and a charging plug 102 for plugging into a vehicle 150 to be charged. The charging cable 101 is fastened to the carrier structure 103. The device 100 further has a cable transport device 110 with a cable transport element 111 which is coupled to the charging cable 101 in such a way that the charging cable 101 is movable relative to the carrier structure 103. The cable transport device 110 further has an operating element 106 which is coupled to the cable transport element 111 in such a way that control commands for controlling the cable transport element 111 can be input by a user 109 in order to position the charging plug 102 in the charging zone 104.

The carrier structure 103 is fastened to the ground 115, for example as a support column or ground support 105, and arranged beside the charging zone 104. The carrier structure 103 serves for fastening the device components to a building or to the ground 115. The carrier structure 103 carries the charging cable 101, in particular. Furthermore, the cable transport device 110 with the corresponding cable transport element 111 is provided on the carrier structure 103. The operating element 106 can also be fastened to the ground support 105.

The charging cable 101 is coupled, electrically connected, to a charge distributor (dispenser) 119, which is arranged on the carrier structure 103.

The cable transport device 110 has a control rod 118 in the exemplary embodiment shown. The control rod 118 may be designed to be longitudinally telescopically adjustable, for example, and/or may be arranged in a pivotable manner on the ground support 105 in such a way that the charging cable 101 can be pivoted into and out of the charging zone 104. For example, the charging cable 101 can be coupled to the control rod 118 at one or more fastening points. The charging cable 101 can have loops between the individual fastening points. For example, if the length of the control rod 118 is reduced, large loops exist between the fastening points. When the control rod 118 is extended to its maximum length, the charging cable 101 may be virtually stretched between the fastening points. The control rod 118 may be designed, for example, to be foldable or retractable in a telescopic manner. Furthermore, the control rod 118 can be fastened to the ground support 105, for example, in a pivotable manner by means of a hinge in order to thus pivot the charging cable 101 into or out of the charging zone 104. The change in length or the pivoting of the control rod 118 will be controlled by the cable transport device 110 by means of an electrical actuator.

The operating element 106 provides an input option, with the result that a user can input control commands for controlling the cable transport element 111. For this purpose, the operating element 106 can have a multiplicity of different mechanical input options, such as buttons, sliders or switches.

The cable transport device 110 can be controlled based on the control commands. The control commands specify, for example, the cable length of the charging cable 101 or specify position data or movement data for a control mechanism of the cable transport element 111.

When the vehicle 150 is located in the charging zone 104 and the charging plug 102 is at a distance from the vehicle 150, the user 109 can actuate the operating element 102 in order to instruct the cable transport device 110 to move or position the charging plug 102 in the vicinity of the charging socket of the vehicle 150. After the charging process, the user 109 can use the operating element 106 to control the cable transport device 110 accordingly in order to remove the charging cable 101 or the charging plug 102 from the vehicle 150, so that the vehicle 150 can drive out of the charging zone 104 with a reduced risk of damage to the charging cable 101.

In the exemplary embodiment shown, an operating element 106 is further arranged on the charging cable 101, in particular on the charging plug 102. Thus, the operating element 106 moves together with the charging plug 102. The user 109 can grasp the charging plug 102 and control it in its position via the attached operating element 106. The user 109 can thus guide the operating element 106, together with the charging plug 101, to a desired position, wherein the movement forces are generated completely or almost completely by the cable transport device 110. The user 109 only accordingly inputs control commands via the operating element 106.

The cable transport device 110 has a receiving device 107 for wirelessly receiving the control commands from the operating element 106, wherein the operating element 106 has a transmitting device for transmitting the control commands input by the user to the receiving device 107. The operating element 106 can thus be arranged away from the cable transport device 110. For example, the operating element 106 may be implemented in a smartphone belonging to a user 109.

The operating element 106 further has a display element 108 which is configured to indicate information regarding the actual position of the charging plug 102 and/or to display information regarding the charging state of the charging cable 101. In particular, the display element 108 may be a screen on which, for example, the position of the charging plug 102 in relation to the charging zone 104 or the vehicle 150 is shown, in particular in real time. Furthermore, the operating element 106 may have a touch-sensitive (capacitive or resistive) screen (touchscreen) in order to input control commands from a user 109.

The device 100 may further have a control unit 116 which is coupled to the cable transport device 110 and to the operating element 106 for the purpose of exchanging data or signals. The control unit 116 may have, for example, the receiving device 107 which receives the control commands from the operating element 106 and accordingly processes and also provides them for the cable transport device 110.

The operating element 106 can also be coupled, in a wireless or wired manner, to an electricity source or a charge distributor (dispenser) 119 for charging the vehicle 150 in such a way that control commands for controlling a charging process can be input by the user 109 by means of the operating element 106. In addition to the control function of the position of the charging plug 101, the operating element 106 can thus also have a control function with regard to the charging process. For example, the operating element 106 can send control commands regarding the start and completion of a charging process to the charge distributor 119 or to an intermediate control unit 116.

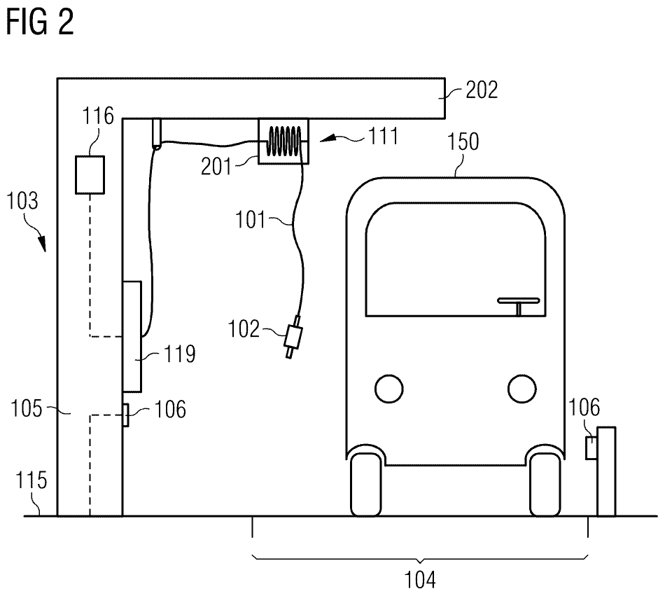

FIG. 2 shows a schematic representation of a device 100 according to the invention, in which the cable transport element 111 is designed as a cable winch 201 and a vehicle 150 is located in the charging zone 104. The device 100 from FIG. 2 has similar features to the embodiment from FIG. 1, wherein a crossbeam 201, which extends over the charging zone 104, is arranged on the ground support 105 at a distance from the ground 115. The crossbeam 202 has a sufficient height to the ground 115, such that a vehicle 150 can be positioned under the crossbeam 150 for charging.

The cable transport element 111 is designed as an electrically drivable cable winch 201, on which the charging cable 101 is rolled up, wherein the operating element 106 is configured such that control commands with respect to control of the cable winch 201 for rolling up and unrolling the charging cable 101 can be input. Control signals can be transmitted from the operating element 106 that is spaced apart to the cable winch 201 and the charging cable 101 can be rolled up or unrolled accordingly. In particular, the cable winch is mounted on the crossbeam 202 which runs transversely above the ground 115 at a distance from the latter. Accordingly, when unrolling the charging cable 101, the charging plug 102 is lowered vertically from the top down until the user 109 can grasp the charging plug 102 and plug it into the charging socket of the vehicle 150.

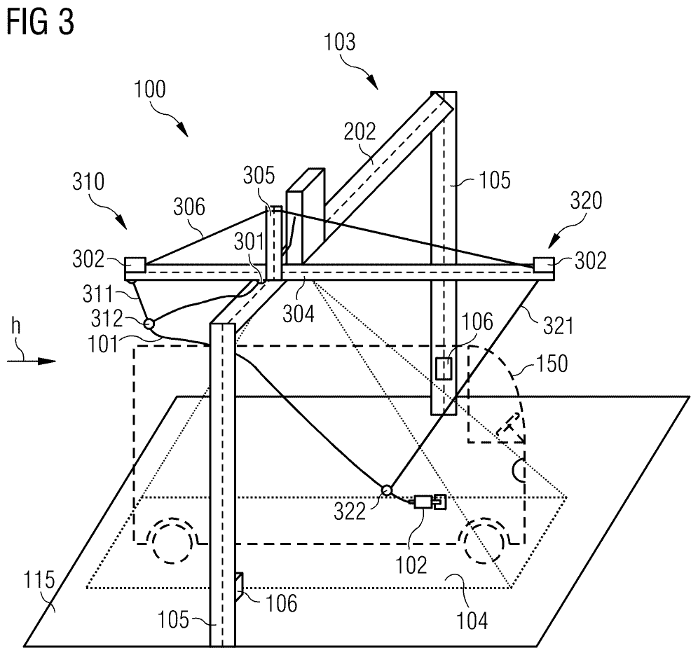

FIG. 3 shows a schematic representation of the cable transport device 110 having two cable pull devices 310, 320, wherein a vehicle 150 is positioned in the charging zone 140.

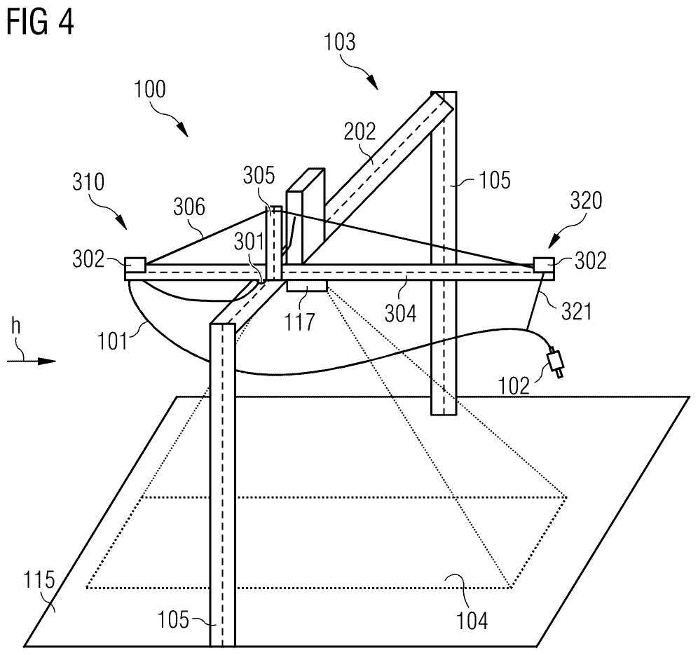

FIG. 4 shows a schematic representation of the device 100 according to the invention from FIG. 3, wherein no vehicle 150 is located in the charging zone 104.

The carrier structure 103 has a crossbeam 202 on which a cable pull device 310 and a second cable pull device 320 of the cable transport device 110 are arranged. The crossbeam 202 is fastened to the ground 115 by means of two ground supports 105, for example made of a steel structure or concrete, such that a corresponding ground support 105 is provided at both ends of the crossbeam 202.

The carrier structure 103 has a boom 304, on which the cable pull device 310 and the further cable pull device 320 are arranged. The boom 304 is fastened to the crossbeam 202 and projects laterally with respect to the extension direction of the crossbeam 202. Charging components, such as a charge distributor (dispenser) 119, may be arranged on the crossbeam 202, wherein the cable pull devices 310, 320 are fastened to the boom 304 at a distance from one another. The boom 106 may consist for example of a solid material or represent a truss.

In particular, the boom 304 is formed at a right angle to the extension direction of the crossbeam 104. The vehicle 150 may enter the device 100 for example in a predetermined entry direction. The crossbeam 202 extends for example transversely to the entry direction, such that the vehicle 150 can be positioned under the crossbeam 202. The boom 304, which extends in particular at a right angle from the crossbeam 202, thus extends parallel to the entry direction and thus along a side face of the positioned vehicle 150. The cable pull devices 310, 320 arranged at a distance from one another on the boom 304 thus extend along the side face of the positioned vehicle 150. The position of the charging plug 102 along the side faces of the vehicle 150 can thus be adjusted by adjusting the lengths of the corresponding carrier cables 311, 312 and the cable pull devices 310, 320.

The cable pull device 310 has the first carrier cable 311 which fastens the charging cable 101 to the first suspension point 312. In other words, the charging cable 101 hangs down from the boom 304 by way of the carrier cable 311. The first carrier cable 311 may be fastened, for example in a detachable or non-detachable manner, to the charging cable 101 at the first suspension point 312. Accordingly, the further cable pull device 320 is fastened, in a detachable or non-detachable manner, to the charging cable 101 at the second suspension point 322 by way of the further carrier cable 321, such that the charging cable 101 is suspended from the boom 304 by way of the second carrier cable 321.

Each of the carrier cables 311, 321 can individually adjust the distance between the corresponding suspension point 312, 322 and the carrier structure 103. In the case of an arrangement having two cable pull devices 310, 320, the charging cable 101 first of all extends from a coupling point 301 on the carrier structure 103, for example always on the crossbeam 202 or the boom 304, to a cable pull device 310, or to a coupling at the first suspension point 312. From there, the charging cable 101 extends to the further cable pull device 320, or to the further suspension point 322 on the further carrier cable 321. From the further suspension point 322, the charging cable 101 extends onward as far as its end, at which the charging plug 102 is arranged.

The ground clearance between the suspension points 312, 322 and the ground 115 is individually adjusted by adjusting the cable lengths of the carrier cables 311, 321. Thus, in an inactive state in which no vehicle 150 is positioned at the device 110 (see FIG. 4), the suspension points 312, 322 can be adjusted in the direction of the carrier structure 103 such that the charging cable 101 is far from the ground in the vicinity of the carrier structure 103. After a vehicle 150 has maneuvered in particular under the crossbeam 202 and is positioned at a predetermined position or charging position relative to the carrier structure 103, the cable lengths of the carrier cables 311, 321 can be increased specifically such that a user can grasp the charging plug 102 and can plug it into the charging socket of the vehicle 115 (FIG. 3).

The charging cable 101 is configured in such a way that the charging cable 101 extends from the coupling point 301 to the first suspension point 312 and then to the second suspension point 322, wherein the charging cable 101 is arranged on the carrier structure 103, the cable pull device 310 and the further cable pull device 320 in such a way that the coupling point 301 is between the first suspension point 311 and the further suspension point 322 along a horizontal direction component h. The charging cable 101 initially hangs down from the crossbeam 202 of the carrier structure 103 from the coupling point 101. The charging cable 101 then extends to the first suspension point 312, forms a loop and extends in the opposite direction to the further suspension point 322. The region of the charging cable 101 between the coupling point 301 and the further suspension point 322 thus forms a C-shaped course. The region of the loop at the suspension point 312 can be flexibly adjusted in the direction of the ground 115 based on the detected sensor data from the sensor device 106. Accordingly, the region at the charging plug 102 or at the further suspension point 322 can also be flexibly adjusted in the direction of the ground 115. The shape of the cable course of the charging cable 101 can be set depending on how the length ratios between the carrier cable 311 and the further carrier cable 312 are formed.

The boom 304 has, between two boom ends, a reinforcement beam 305 which protrudes from the boom 304 perpendicularly upward, in the opposite direction to the ground 115. A tensioned reinforcement cable 306 connects the boom ends and the reinforcement beam 305 in order to stabilize the boom 304.

The cable pull device 310 and the second cable pull device 320 each have an electrical cable winch 302. The cable winches 302 can roll up and unwind the carrier cables 311, 321 accordingly. The corresponding cable winches 302 can be controlled by means of the cable transport device 110 based on the sensor data from the sensor device 106.

The electrical cable winches 302, which control the length of the carrier cables 311, can be controlled by the user with the operating element 106. Thus, the user 109 can set an exact positioning of the charging plug.

In addition, it should be understood that the term “comprising” does not exclude any other elements or steps, and the terms “a”, “an” or “one” do not exclude a multiplicity. It should also be noted that features or steps which have been described with reference to one of the above exemplary embodiments can also be used in combination with other features of steps of other above-described exemplary embodiments.

Irrespective of the grammatical gender of a specific term, persons with male, female, or other gender identity are also included.

The following is a summary list of reference numerals and the corresponding structure used in the above description of the invention:
100 Device
101 Charging cable
102 Charging plug
103 Carrier structure
104 Charging zone
105 Ground support
106 Operating element
107 Receiving device
108 Display element
109 User
110 Cable transport device
111 Cable transport element
115 Ground
116 Control unit
118 Control rod
119 Charge distributor
150 Vehicle
201 Drivable cable winch for charging cables
202 Crossbeam
301 Coupling point
302 Cable winch
304 Boom
305 Reinforcement beam
306 Reinforcement cable
310 Cable pull device
311 Carrier cable
312 Suspension point
320 Further cable pull device
321 Further carrier cable
322 Further suspension point
h Horizontal direction component

1. A device for transporting a charging cable for charging a vehicle, the device comprising:
a carrier structure to be arranged at a charging zone for charging a vehicle;
a charging cable fastened to said carrier structure, said charging cable being connected, or connectible to an electricity source and having a charging plug for plugging into the vehicle to be charged;
a cable transport device having a cable transport element that is coupled to said charging cable and is configured to move said charging cable relative to said carrier structure;
said cable transport device further having an operating element coupled to said cable transport element and configured to receive control commands from a user for controlling said cable transport element, and said cable transport device being configured to move said charging plug in the charging zone in dependence on control commands received from the user.

2. The device according to claim 1, wherein said operating element is arranged on said carrier structure.

3. The device according to claim 1, wherein said operating element is arranged on said charging cable.

4. The device according to claim 3, wherein said operating element is arranged on said charging plug.

5. The device according to claim 1, wherein:
said cable transport device includes a receiving device for wirelessly receiving the control commands from said operating element; and
said operating element has a transmitting device for transmitting the control commands input by the user to said receiving device.

6. The device according to claim 5, wherein:
said operating element is configured for wireless coupling to said cable transport device for transmitting the control commands; and
said operating element is a device selected from the group consisting of a computer, a smartphone, and a tablet computer.

7. The device according to claim 1, wherein said operating element has a display element configured to indicate information regarding at least one of an actual position of said charging plug or a charging state of said charging cable.

8. The device according to claim 1, wherein said operating element is configured for coupling, in a wireless or wired connection, to an electricity source for charging the vehicle such that control commands for controlling a charging process can be input by the user via said operating element.

9. The device according to claim 1, wherein said operating element has a piezoelectric element configured to generate a control signal upon an actuation by the user.

10. The device according to claim 9, wherein said piezoelectric element is configured to generate the control signal without additional energy provision.

11. The device according to claim 1, wherein:
said cable transport element is a control rod configured for at least one of longitudinal adjustment or for pivoting said charging cable into or out of the charging zone; and
said operating element is configured to receive control commands with respect to a pivoting and/or with respect to an adjustment of a length of said control rod.

12. The device according to claim 1, wherein:
said cable transport element has a cable winch configured to selectively roll up or unroll said charging cable; and
said operating element is configured to receive control commands with respect to a rolling-up or unrolling of said charging cable.

13. The device according to claim 1, wherein:
said cable transport device is fastened to said carrier structure and has a cable pull device with a carrier cable forming a cable transport element;
said carrier cable is fastened between a suspension point of said charging cable and said carrier structure;
said cable pull device is configured to adjust a free length of said carrier cable to variably specify a spacing distance between said first suspension point and the ground; and
said operating element is coupled to said cable pull device and is configured to receive control commands with respect to the free length of said carrier cable.

14. The device according to claim 13, wherein:
said cable transport device has a further cable pull device with a further carrier cable forming a cable transport element;
said further cable pull device is fastened to said carrier structure at a distance from said cable pull device;
said further carrier cable is fastened between a further suspension point of said charging cable which is formed at a distance from said suspension point and said carrier structure;
each of said cable pull device and said further cable pull device are configured to adjust the free lengths of said carrier cable and of said further carrier cable independently of one another to enable a respective distance of said suspension point and of said further suspension point to the ground to be variably specified; and
said operating element is coupled to said further cable pull device and is configured to receive control commands with respect to the free length of said further carrier cable.

15. A method for transporting a charging cable for charging a vehicle, the method comprising:
providing a device according to claim 1; and
positioning the charging plug in the charging zone based on control commands received by the operating element for controlling the cable transport element.
